(19) United States
(12) Patent Application Publication
(10) Pub. No.: US 2022/0107658 A1
(43) Pub. Date: Apr. 7, 2022

(54) THERMOSTATIC ASSEMBLY, IN PARTICULAR THERMOSTATIC CARTRIDGE

(71) Applicant: VERNET, Ollainville (FR)

(72) Inventors: Nicolas POTTIE, Le Perray En Yvelines (FR); Frédéric JAGER, Arpajon (FR)

(21) Appl. No.: 17/430,620

(22) PCT Filed: Feb. 19, 2020
(86) PCT No.: PCT/EP2020/054306

§ 371 Date: Aug. 12, 2021

(30) Foreign Application Priority Data
Feb. 20, 2019 (FR) 1901696

(51) Int. Cl. G05D 23/13; F16K 31/00; F16K 11/065

(52) U.S. Cl. CPC G05D 23/1346; F16K 11/0655; F16K 31/002

(57) ABSTRACT

This assembly comprises a casing, a thermostatic element and a slide. This slide is movable along an axis of the element so a first seat of the slide and a first seat of the casing delimit between them a first passage running around the axis and in which a hot fluid inlet opens and a second seat of the slide and a second seat of the casing delimit between them a second passage running around the axis and in which a cold fluid inlet opens. These first and second passages are closed when the slide occupies a first or second axial position, respectively, in which the first or second seat of the slide is in axial abutment against the first or second seat of the casing, respectively. They are open continuously all around the axis when the slide occupies an intermediate position between the first and second positions.

The present invention relates to a thermostatic assembly, in particular a thermostatic cartridge.

To regulate the temperature of a mixture of a hot fluid and a cold fluid, in particular a mixture of hot and cold water in a sanitary installation, it is known to use a thermostatic element and a slide, which are arranged inside a hollow outer casing, typically a cartridge body to be fitted into a faucet body. The thermostatic element comprises a piston, which is normally fixed with respect to the casing, and a thermosensitive body, with respect to which the piston is movable in translation along an axis under the effect of thermal expansion of the thermostatic element, the slide being integral with the thermosensitive body. The slide is mounted so that it can move in translation inside a chamber of the casing so as to close off, in respective inverse proportions, a first passage, which is delimited axially between a first seat of the slide and a first seat of the casing and which is supplied with hot fluid by a hot fluid inlet delimited by the casing, and a second passage, which is axially delimited between a second seat of the slide and a second seat of the casing and which is supplied with cold fluid by a cold fluid inlet delimited by the casing. The hot fluid and the cold fluid that the slide allows to pass through the first and second passages to reach the chamber mix there and form, downstream of the slide, a mixed fluid that leaves the casing flowing along the thermosensitive body of the thermostatic element. By modifying the position of the piston in relation to the casing, generally by means of an ad hoc adjustment mechanism, it is possible to set the thermostatic regulation temperature, i.e. the balancing temperature around which the temperature of the mixed fluid is regulated. An example of such a cartridge is provided by FR 2 921 709.

In certain operating configurations, the slide can be controlled in displacement so that its first seat is very close axially to the first seat of the casing without being pressed against the latter, which amounts to saying that the first passage remains very slightly open, or so that its second seat is very close axially to the second seat of the casing without being pressed against the latter, which amounts to saying that the second passage remains very slightly open. These operating configurations are encountered in particular when the temperature of the mixed fluid is very close to the temperature of the cold fluid or very close to the temperature of the hot fluid and/or when the hot and cold fluid inlets have a very large pressure differential. The small axial distance between the slide and the first or second seat of the casing induces a significant increase in the speed of the fluid flow in the first or second passage and creates a depression between the slide and this seat of the casing. This depression tends to close the corresponding passage further, which reinforces the depression, until it causes the complete closure of the passage by driving the slide under the effect of its suction against the seat of the casing. The closing of the passage abruptly interrupts the flow and, consequently, the aforementioned depression. The slide can then return to its commanded position, moving away from the seat of the casing against which it was sucked, which leads to re-establishing the flow of fluid, but again with a very high speed due to the small distance between the slide and the seat of the casing, which re-initiates the suction effect, and so on. The succession of these creations and interruptions of the suction of the slide against the seat of the casing, of which the slide is controlled to be very close to, generates shrill whistles, which are unpleasant for the user, as well as vibrations and cavitations, which are detrimental to the longevity of the thermostatic cartridge.

This problem was considered in US 2014/0261744, which, to remedy it, provides for stabilizing the slide in the chamber by pinching the slide along the direction of its axis regardless of its axial position between its extreme position where it closes the first passage and its opposite extreme position where it closes the second passage. To do this, each of the two seats of the slide is provided with reliefs made of flexible material, which, whatever the axial position of the slide, remain in elastic abutment against the corresponding seat of the casing and which are squeezed when the slide is operated to move closer to this seat of the casing. This solution amounts to a damped constraint of the slide between the seats of the casing permanently, avoiding the occurrence of vibrations. However, this solution leads to the fact that the passages for the hot and cold fluids, delimited between the slide and the casing, cannot be opened continuously all around the axis when the slide occupies an intermediate position between its two extreme positions. As a result, the maximum quantities of hot and cold fluid that can be admitted are reduced, which limits the flow performance. This also results in compounding the increase in the forces required to move the slide, which degrades the thermostatic control performance, in particular the speed and precision of the slide drive by the thermostatic element.

The purpose of the present invention is to propose a thermostatic assembly, in particular a thermostatic cartridge, which, while being efficient, prevents or limits the phenomenon of whistling and vibrations described above.

To this end, the subject matter of the invention is a thermostatic assembly, including:
a casing in which are defined:
   a chamber which defines an axis and in which a hot fluid and a cold fluid mix to form a mixed fluid,
   a hot fluid inlet through which the hot fluid enters the chamber from outside the casing,
   a cold fluid inlet through which the cold fluid enters the chamber from outside the casing, and
   a mixed fluid outlet through which the mixed fluid contained in the chamber leaves the casing,
a thermostatic element which includes a thermosensitive body, arranged to be in contact with the mixed fluid, and a piston, connected to the casing, the thermosensitive body and the piston moving relative to each other along the axis according to the temperature of the mixed fluid, and
a slide for regulating the temperature of the mixed fluid, this slide being arranged in the chamber so as to be movable along the axis in such a way that:
   a first seat of the slide and a first seat of the casing delimit between them, along the axis, a first passage which runs around the axis and into which the hot fluid inlet opens in the chamber, this first passage being closed when the slide occupies a first axial position in which the first seat of the slide is in axial contact against the first seat of the casing,
   a second seat of the slide and a second seat of the casing delimit between them, along the axis, a second passage which runs around the axis and on which the cold fluid inlet opens in the chamber, this second passage being closed when the slide occupies a second axial position in which the second seat of the slide is in axial contact against the second seat of the casing, and
   the first and second passages are open continuously all around the axis when the slide occupies an intermediate axial position between the first and second positions,

wherein the slide is connected to the thermosensitive body of the thermostatic element to be displaced along the axis so as to close the first and second passages in respective inverse proportions,

and wherein the thermostatic assembly incorporates:
one or more first reliefs, which are arranged in and/or at inlet and/or at outlet of the first passage and which are shaped to slow down, non-uniformly around the axis, a first fluid flow in the first passage when the slide is axially between the intermediate position and the first axial position, and
one or more second reliefs, which are arranged in and/or at inlet and/or at outlet of the second passage and which are shaped to slow down, non-uniformly around the axis, a second fluid flow in the second passage when the slide is axially between the intermediate position and the second axial position.

The idea behind the invention is to try to reduce the intensity of the suction phenomenon generated in each of the two passages delimited between the slide and the casing when the seats of the slide are very close to the seats of the casing, by slowing down the flow of the fluid in only one part, around the axis, of this passage. To do this, the invention provides that, for each passage, one or more reliefs slow down, partially, or totally, the fluid flow in the passage, by acting on the speed of this flow in a non-uniform manner around the axis. This or these reliefs can in particular slow down the flow in several peripheral portions of the corresponding passage, which are distributed around the axis and between which the fluid flow is not slowed down: at the level of these portions, the phenomenon of suction described above does not appear, so that, even if this phenomenon of suction can appear in the passage between these portions, the intensity of the phenomenon and thus the forces which would tend to displace the slide under the effect of this phenomenon are substantially limited since these forces are applied only to a reduced extent of the passage. Moreover, these reliefs are designed so that, despite their presence, the two passages are open continuously all around the axis when the slide occupies an intermediate position between its two contact positions against the seats of the casing, in other words when the slide is not in the immediate vicinity of either of the two seats of the casing: the reliefs do not therefore degrade the flow and thermostatic regulation performance of the assembly in accordance with the invention.

The slowing down effect produced by the reliefs on the flow of fluid in the passages when the slide is axially close to the seats of the casing may result from the fact that the flow section of these passages does not vary linearly as a function of the displacement of the slide. This is based on a flexible deformation capacity of the reliefs subjected to squeezing between the seats of the slide and the seats of the casing, and/or on the fact that the reliefs locally create pressure losses either directly between the seats, i.e. in each of the passages, or at the inlet of the passage, or at the outlet of the passage. These technical considerations can be applied to multiple embodiments of the thermostatic assembly in accordance with the invention, as detailed below.

According to advantageous optional features of the thermostatic assembly according to the invention:
each of the first and second reliefs is borne by the slide or by the casing;
the or each first relief extends axially across the first fluid flow in and/or at inlet and/or at outlet of the first passage, and the or each second relief extends axially across the second fluid flow in and/or at inlet and/or at outlet of the second passage;
a single first relief, which runs continuously all around the axis and whose axial dimension varies as this first relief is followed around the axis, and/or
a single second relief, which runs continuously around the axis and whose axial dimension varies as this second relief is followed around the axis;
a plurality of first reliefs which are distributed about the axis and which occupy, about the axis, respective portions which are distinct and separate, and/or
a plurality of second reliefs which are distributed around the axis and which occupy respective portions which are distinct and separate around the axis;
the first relief or reliefs protrude from the first seat of the slide or of the first seat of the casing, being made of a flexible material adapted to be deformed by squeezing when the slide is in the first axial position, and/or
the second relief or reliefs protrude from the second seat of the slide or of the second seat of the casing, being made of a flexible material adapted to deform by squeezing when the slide is in the second axial position;
the first relief or reliefs rigidly protrude from the first seat of the slide or from the first seat of the casing, being received in a complementary recess hollowed out in, respectively, the first seat of the casing or the first seat of the slide when the slide is in the first axial position, and/or
the second relief or reliefs rigidly protrude from the second seat of the slide or from the second seat of the casing, being received in a complementary recess hollowed out in, respectively, the second seat of the casing or the second seat of the slide when the slide is in the second axial position;
the first relief or reliefs protrude from a dedicated surface of the slide or of the casing, which is located at inlet of the first passage and which extends the first seat of the slide or the first seat of the casing opposite to the axis without being brought into contact with, respectively, the first seat of the casing or the first seat of the slide whatever the axial position of the slide in the chamber, and/or
the second relief or reliefs protrude from a dedicated surface of the slide or casing, which is located at inlet of the second passage and which extends the second seat of the slide or the second seat of the casing opposite to the axis without being brought into contact with, respectively, the second seat of the casing or the second seat of the slide regardless of the axial position of the slide in the chamber;
the first relief or reliefs protrude from a dedicated surface of the slide or of the casing, which is located at outlet of the first passage and which extends the first seat of the slide or the first seat of the casing toward the axis without being brought into contact with, respectively, the first seat of the casing or the first seat of the slide whatever the axial position of the slide in the chamber, and/or
the second relief or reliefs protrude from a dedicated surface of the slide or of the casing, which is located at outlet of the second passage and which extends the second seat of the slide or the second seat of the casing toward the axis without being brought into contact with, respectively, the second seat of the casing or the second seat of the slide whatever the axial position of the slide in the chamber;
the first relief or reliefs protrude from a surface of the casing, which delimits the hot fluid inlet, and/or
the second relief or reliefs protrude from a surface of the casing, which delimits the cold fluid inlet; and
the thermostatic assembly forms a thermostatic cartridge adapted to be integrally fitted into a faucet body.

The invention will be better understood from the following description, given only by way of example, and made with reference to the drawings in which:

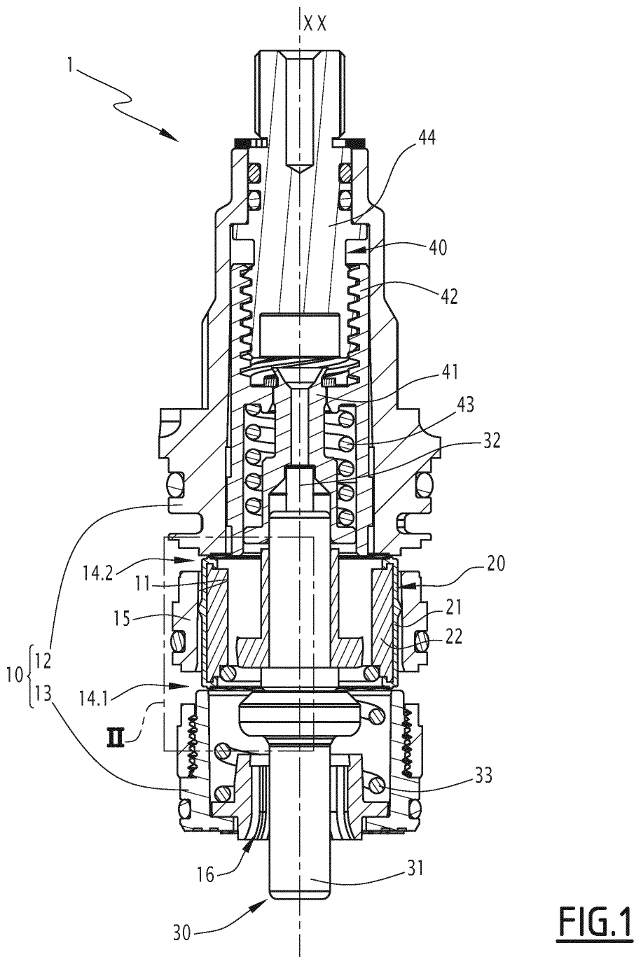

FIG. 1 is a longitudinal schematic section of a thermostatic assembly in accordance with the invention, made in the form of a thermostatic cartridge.

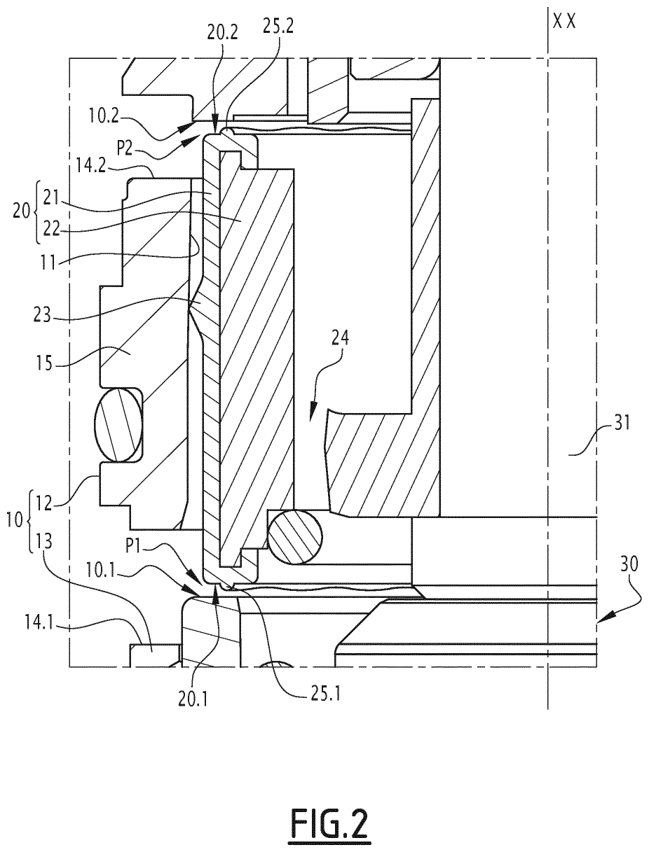

FIG. 2 is a larger scale view of a part II of FIG. 1.

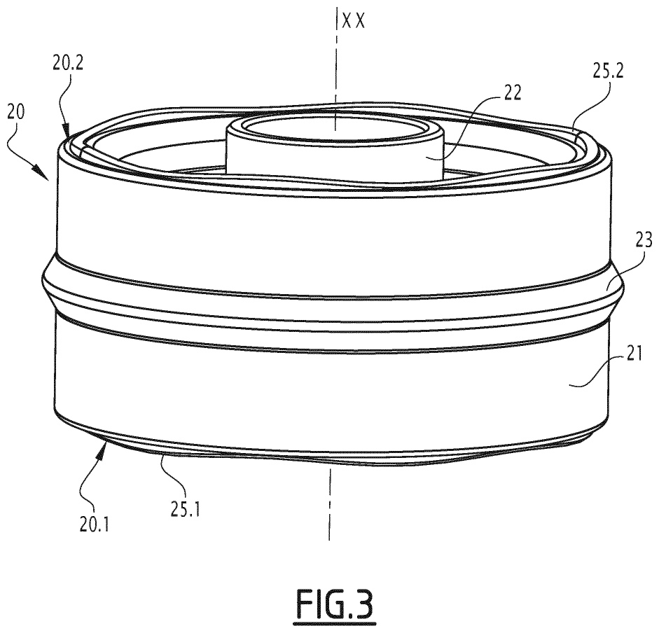

FIG. 3 is a perspective view of a slide of the cartridge of FIG. 1.

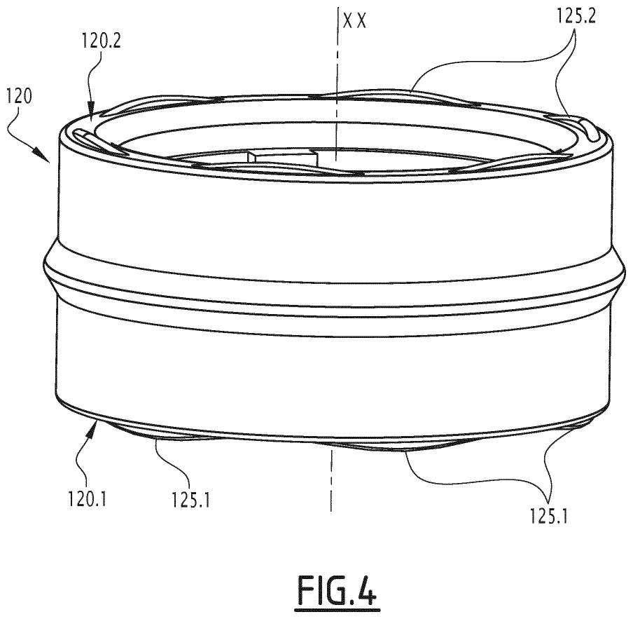

FIG. 4 is a view similar to FIG. 3, illustrating an alternative embodiment of the slide.

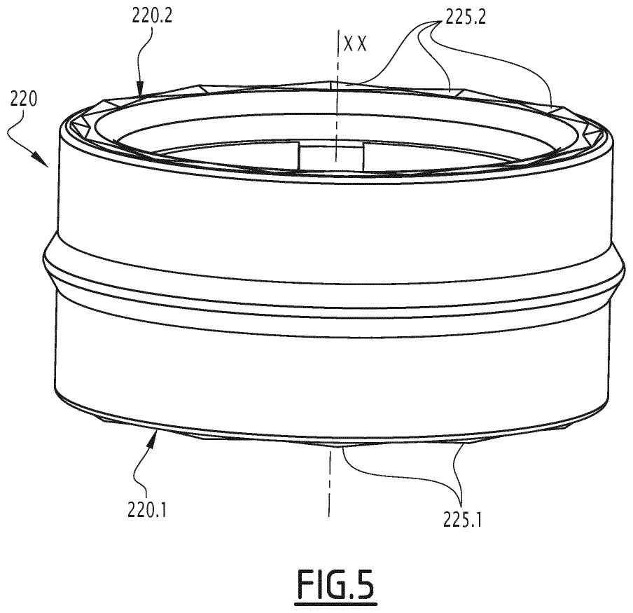

FIG. 5 is a view similar to FIG. 3, illustrating another alternative embodiment of the slide.

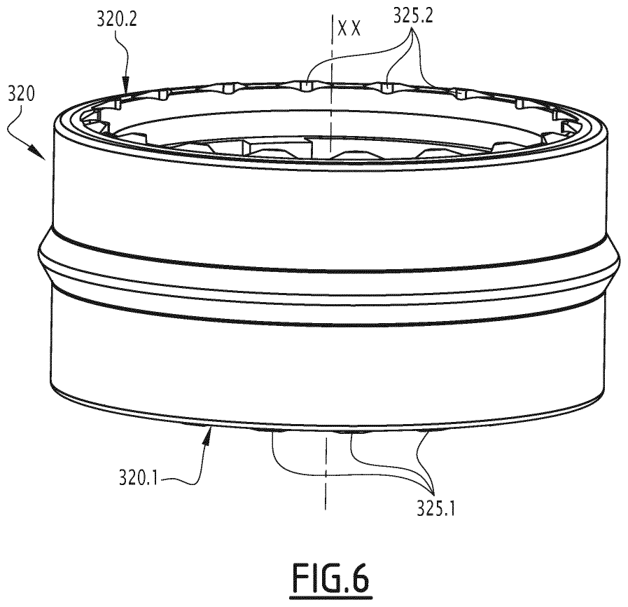

FIG. 6 is a view similar to FIG. 3, illustrating another variant of the slide.

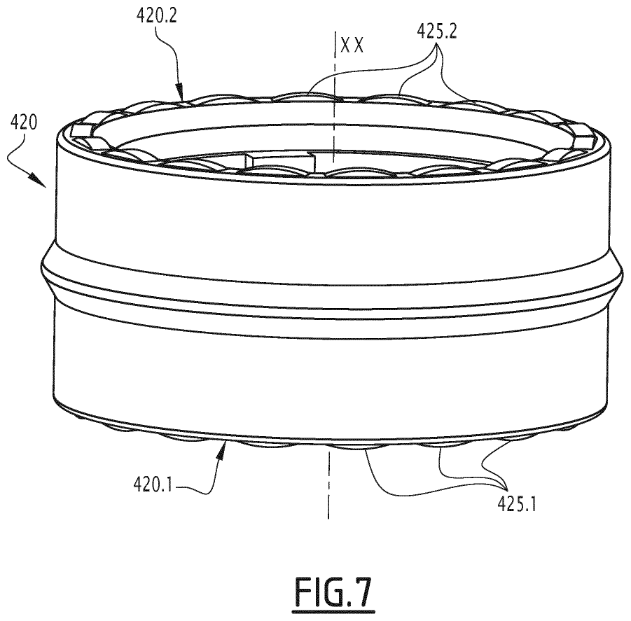

FIG. 7 is a view similar to FIG. 3, illustrating another variant of the slide.

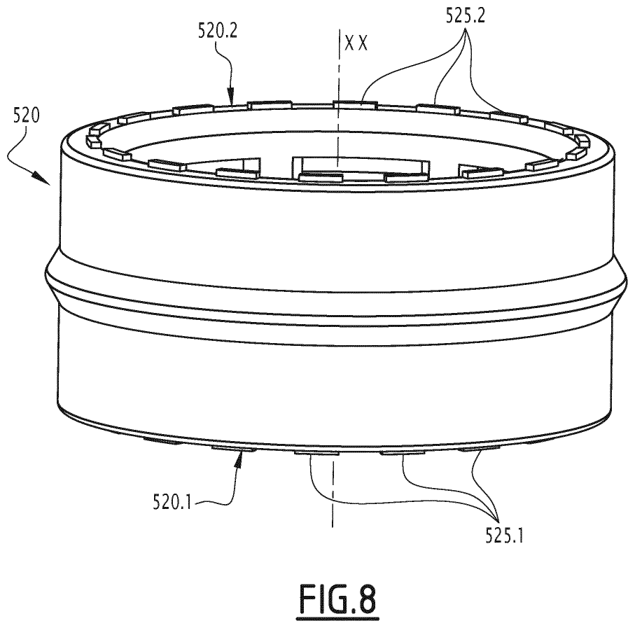

FIG. 8 is a view similar to FIG. 3, illustrating another variant of the slide.

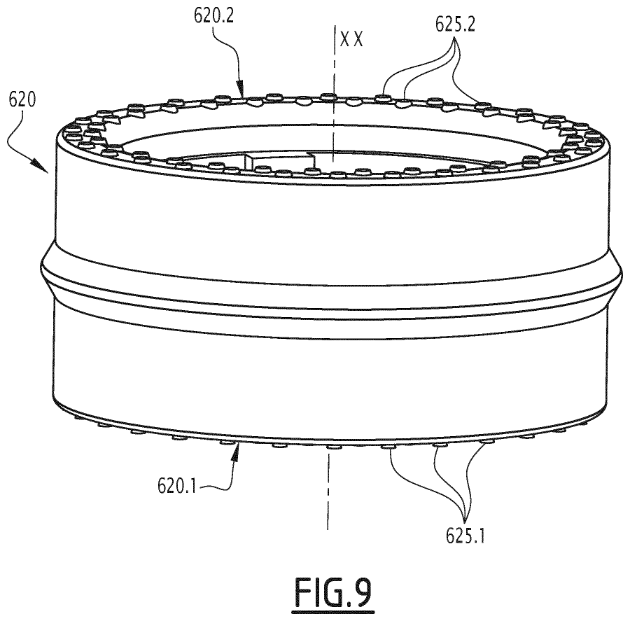

FIG. 9 is a view similar to FIG. 3, illustrating another variant of the slide.

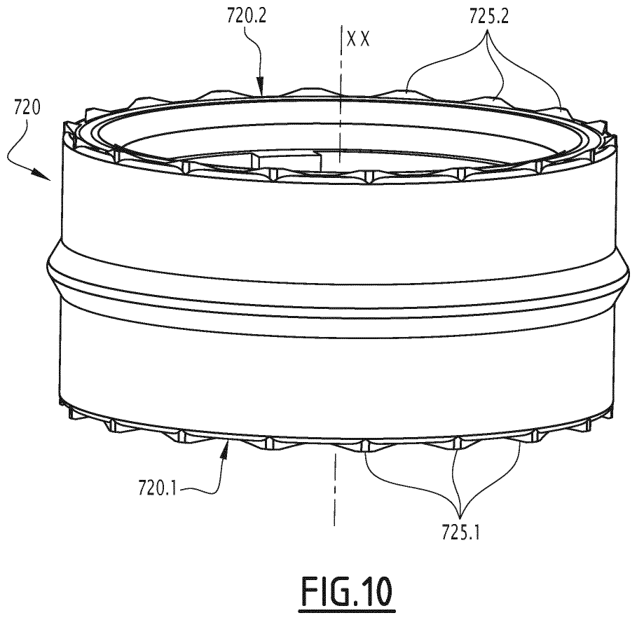

FIG. 10 is a view similar to FIG. 3, illustrating another variant of the slide.

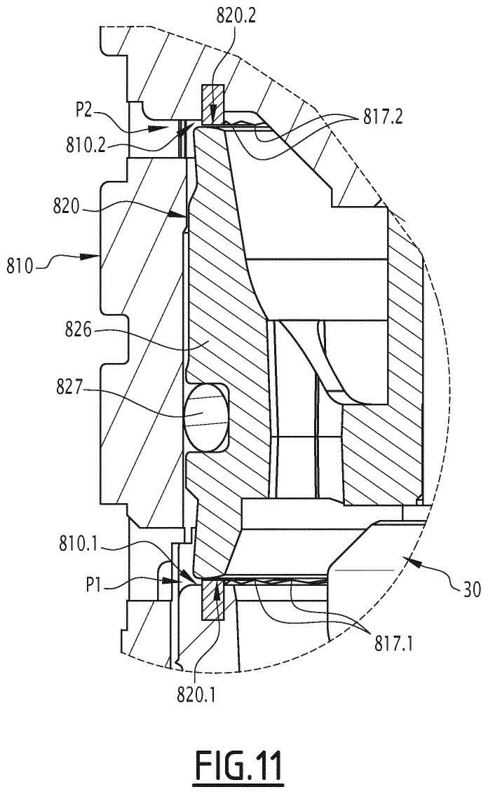

FIG. 11 is a view similar to FIG. 2, illustrating another embodiment of a thermostatic assembly according to the invention.

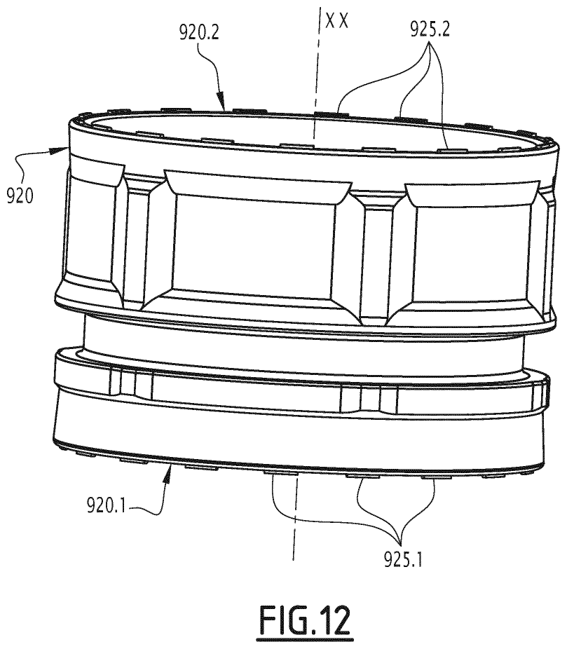

FIG. 12 is a perspective view of a slide belonging to yet another embodiment of a thermostatic assembly in accordance with the invention.

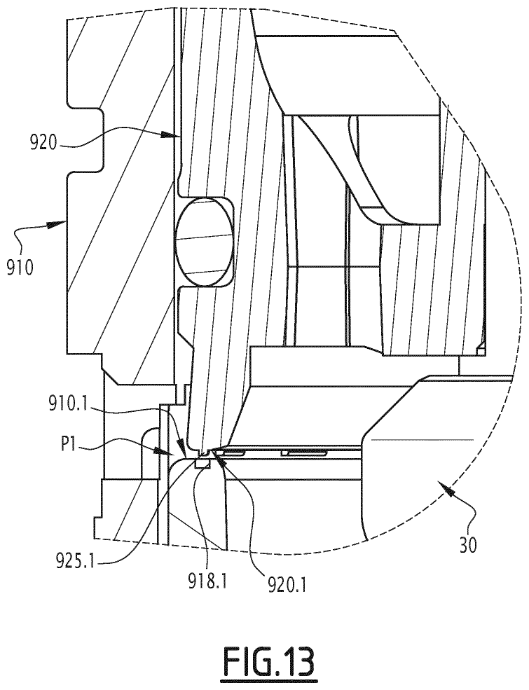

FIG. 13 is a view similar to FIG. 2, illustrating the embodiment associated with the slide of FIG. 12.

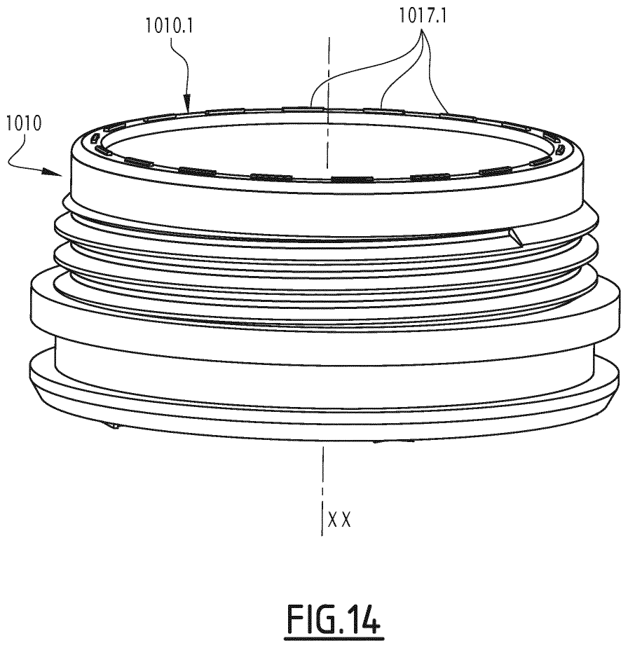

FIG. 14 is a perspective view of a portion of a casing belonging to yet another embodiment of a thermostatic assembly in accordance with the invention.

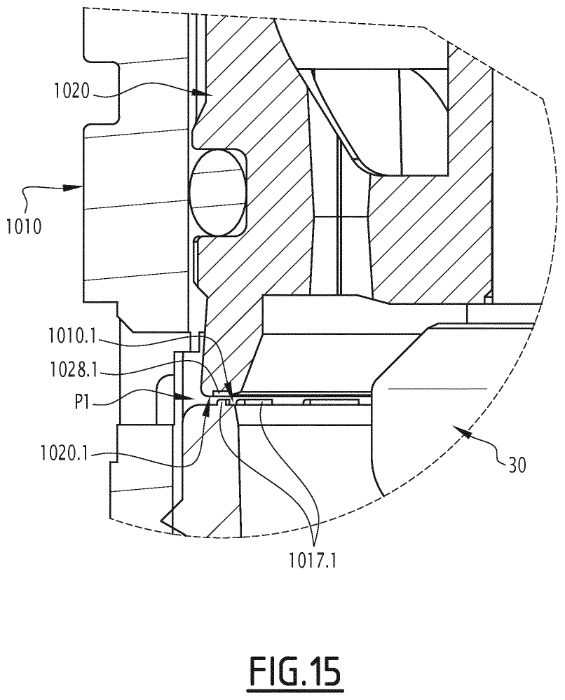

FIG. 15 is a view similar to FIG. 2, illustrating the embodiment associated with the portion of the casing of FIG. 14.

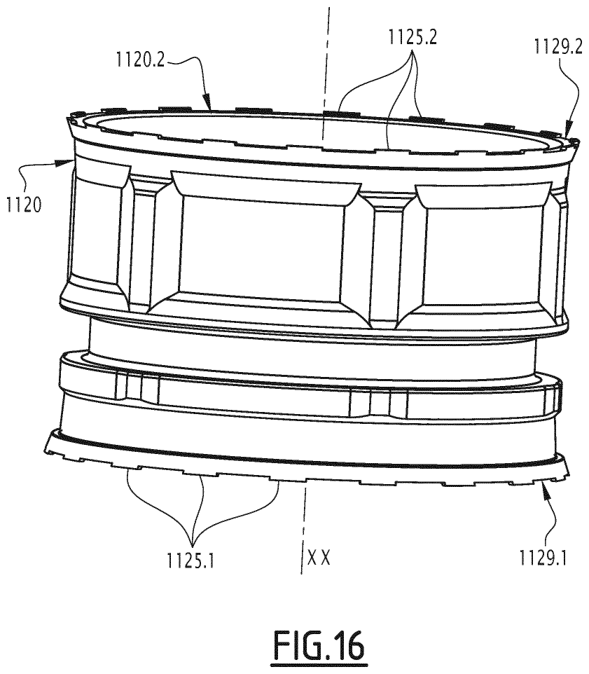

FIG. 16 is a perspective view of a slide belonging to yet another embodiment of a thermostatic assembly in accordance with the invention.

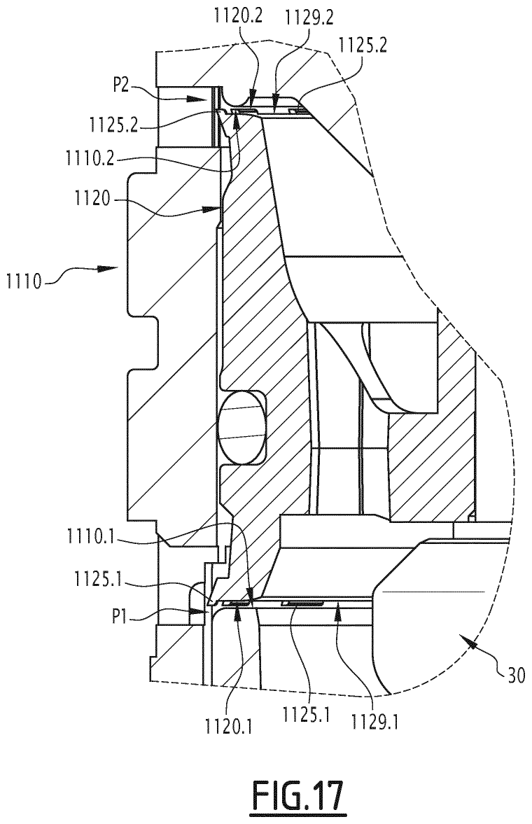

FIG. 17 is a view similar to FIG. 2, illustrating the embodiment associated with the slide of FIG. 16.

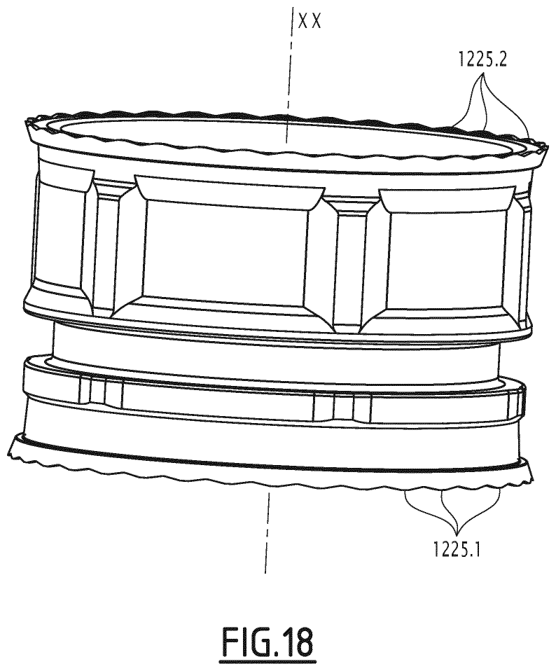

FIG. 18 is a perspective view of a slide belonging to yet another embodiment of a thermostatic assembly in accordance with the invention.

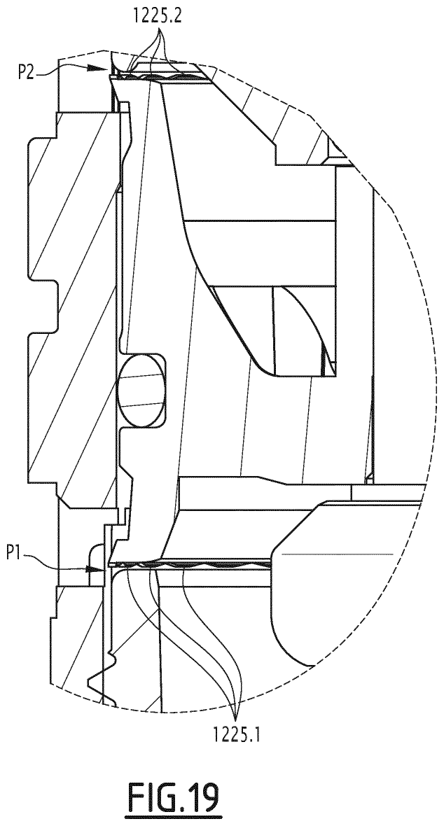

FIG. 19 is a view similar to FIG. 2, illustrating the embodiment associated with the slide of FIG. 18.

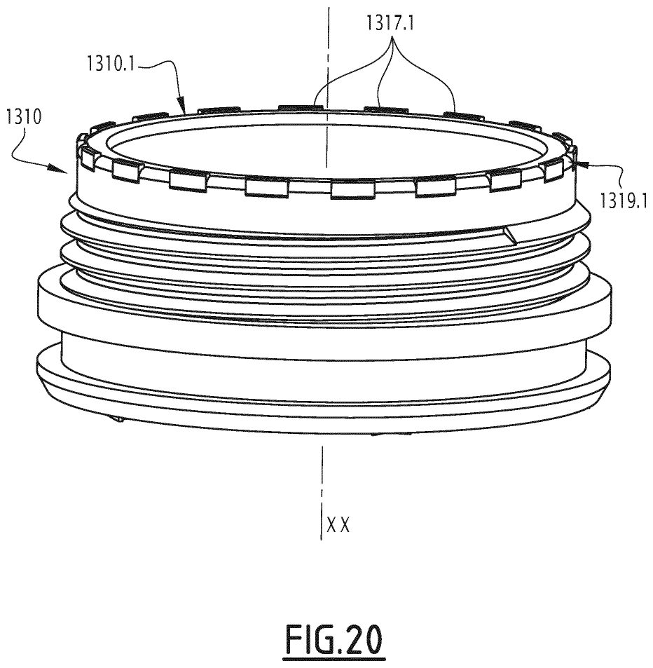

FIG. 20 is a perspective view of a portion of a casing belonging to yet another embodiment of a thermostatic assembly in accordance with the invention.

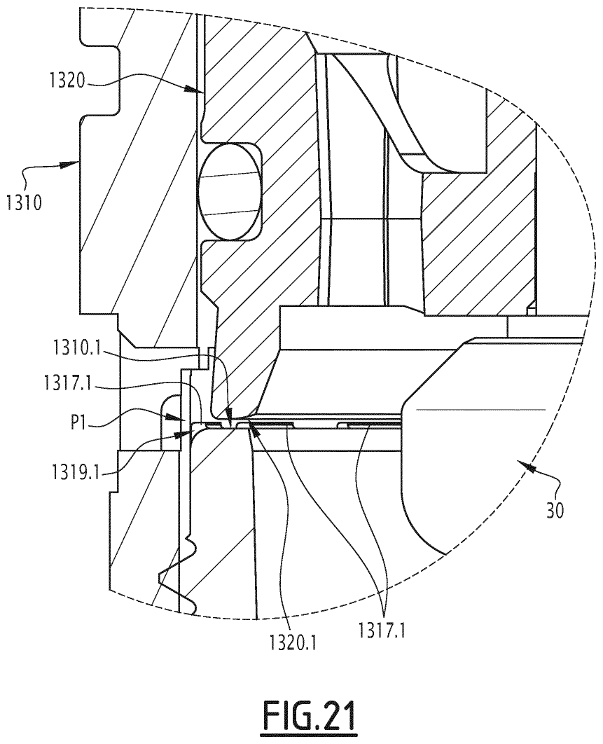

FIG. 21 is a view similar to FIG. 2, illustrating the embodiment associated with the portion of the casing of FIG. 20.

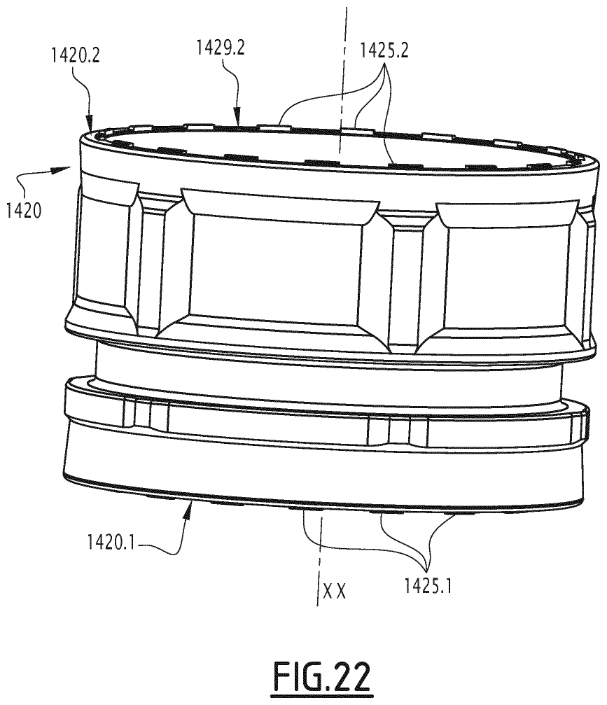

FIG. 22 is a perspective view of a slide belonging to yet another embodiment of a thermostatic assembly in accordance with the invention.

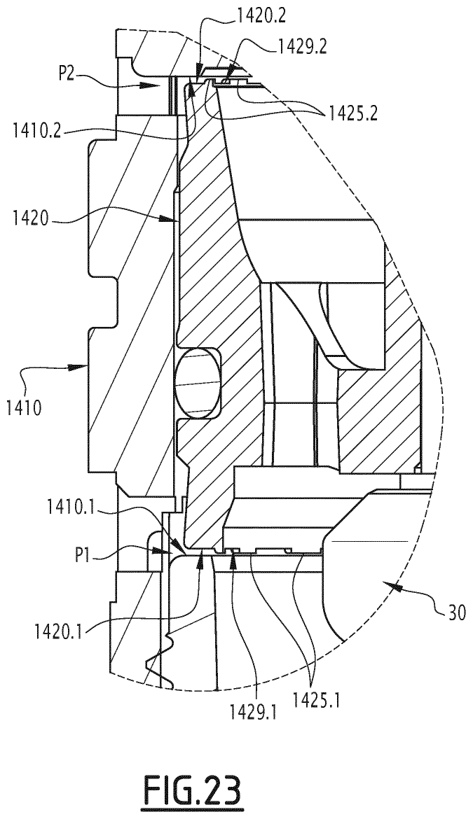

FIG. 23 is a view similar to FIG. 2, illustrating the embodiment associated with the slide of FIG. 22.

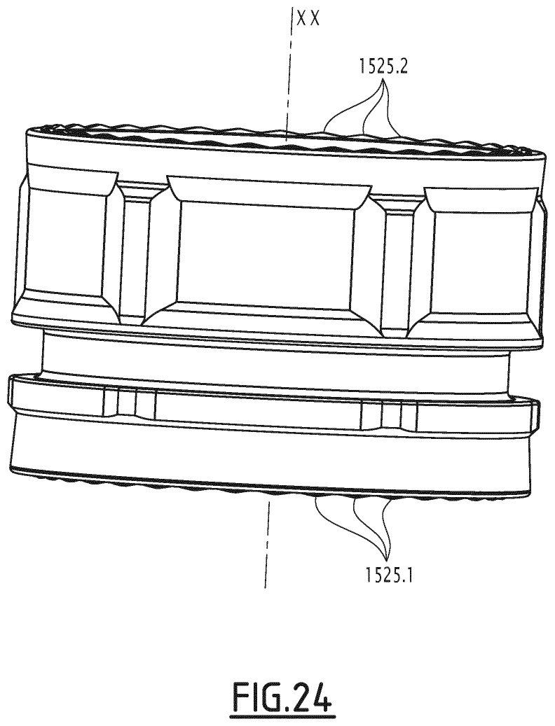

FIG. 24 is a perspective view of a slide belonging to yet another embodiment of a thermostatic assembly in accordance with the invention.

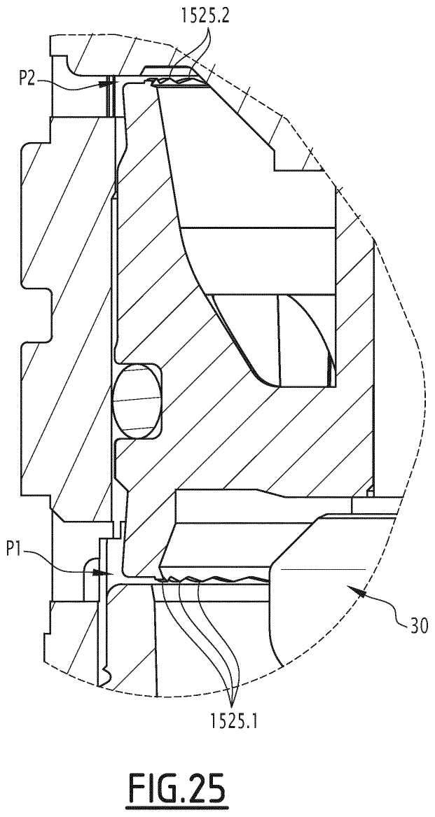

FIG. 25 is a view similar to FIG. 2, illustrating the embodiment associated with the slide of FIG. 24.

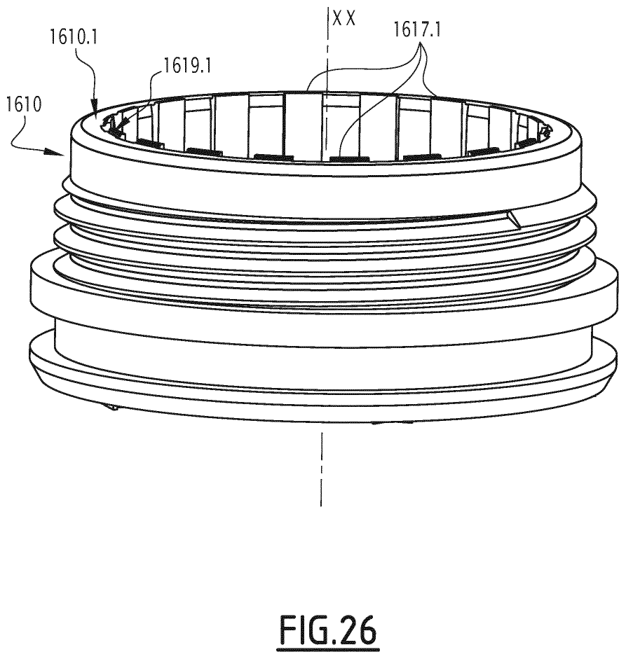

FIG. 26 is a perspective view of a portion of a casing belonging to yet another embodiment of a thermostatic assembly in accordance with the invention.

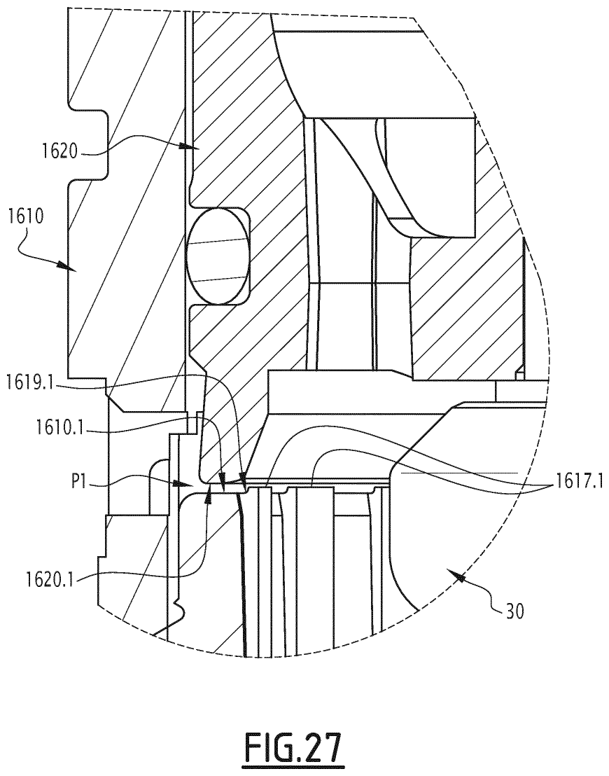

FIG. 27 is a view similar to FIG. 2, illustrating the embodiment associated with the portion of the casing of FIG. 26.

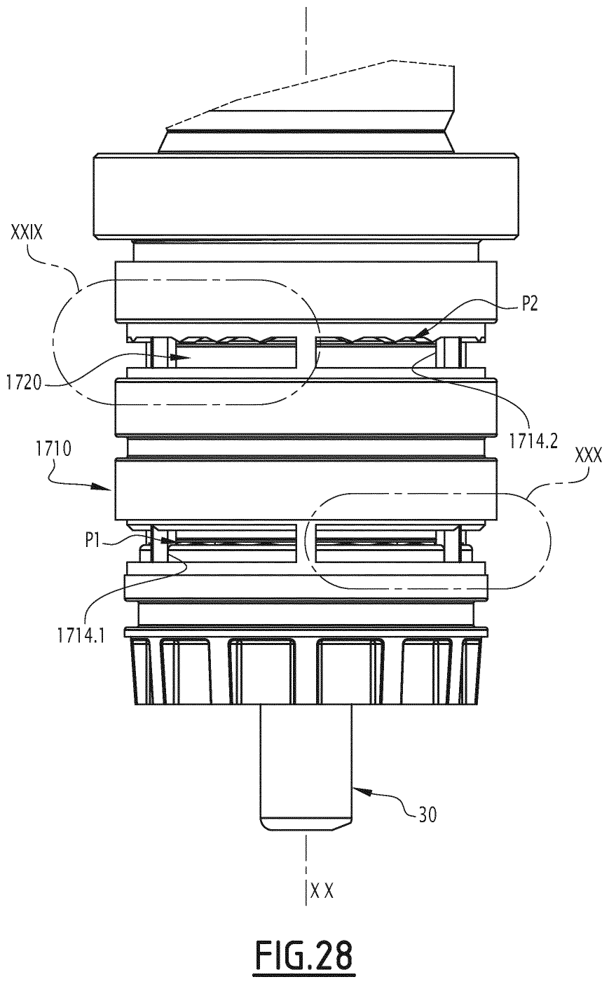

FIG. 28 is an elevation view of yet another embodiment of a thermostatic assembly in accordance with the invention.

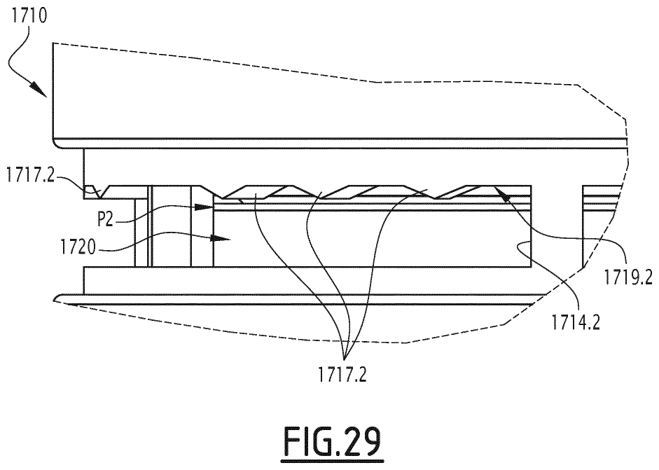

FIG. 29 is a larger scale view of detail XXIX of FIG. 28; and

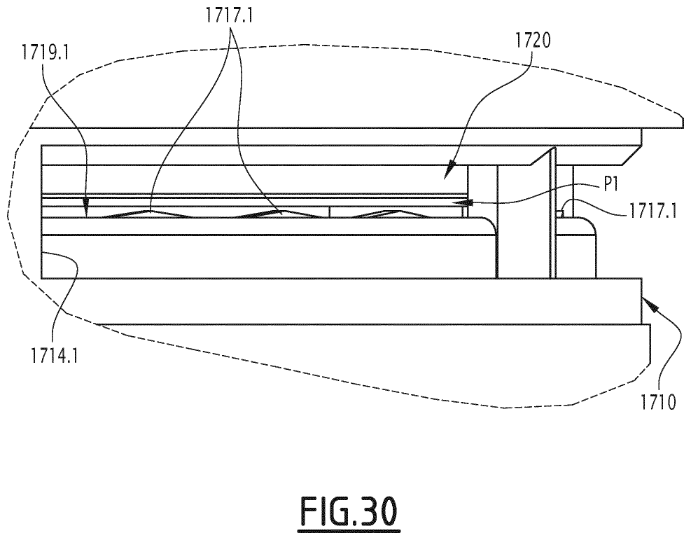

FIG. 30 is a larger scale view of detail XXX of FIG. 28.

FIGS. 1 and 2 show a thermostatic cartridge 1 arranged around and along a central X-X axis. This cartridge 1 is adapted to equip a mixing faucet to be supplied with hot and cold water, not shown as such on the figures, or, more generally, to equip an installation supplied with a hot fluid and a cold fluid to be mixed.

The cartridge 1 includes, as its main external component, a hollow casing 10. This casing 10 presents as a generally tubular shape, which is centered on the X-X axis and which internally delimits a chamber 11 centered on the X-X axis. The hot water and cold water to be regulated by the cartridge 1 are intended to mix inside the chamber 11, forming a mixed water therein.

For convenience, the remainder of the description is oriented with respect to the X-X axis, in the sense that the terms “upper” and “top” correspond to an axial orientation facing the upper part of the figures, while the terms “lower” and “bottom” correspond to an axial direction of opposite sense.

In the embodiment considered in the figures, the casing 10 includes an upper housing 12 to the lower end of which a sleeve 13 is attached, here by screwing. The chamber 11 extends along both the housing 12 and the sleeve 13. The housing 12 and the sleeve 13 are intended to be mounted in a sealed manner in the body of the above-mentioned mixing faucet, with the interposition of O-rings, which are visible in FIG. 1. The design of the casing 10, combining here the housing 12 and the sleeve 13, is not limiting.

The casing 1 presents lateral inlets 14.1 and 14.2 which connect the outside of the casing 1 to the chamber 11. The inlets 14.1 and 14.2 are axially offset from each other along the casing 1, being, in particular at the level of the respective outlets of these inlets into the chamber 11, separated from each other by a side wall 15 of the chamber 11. In practice, the embodiment of each of the lateral inlets 14.1 and 14.2 is not limiting: by way of example, each of these inlets 14.1 and 14.2 may include one or more radial through openings, which extend in circumferential arcs centered on the X-X axis; or each of these inlets 14.1 and 14. 2 extends, at least in part, axially in the thickness of the lateral wall of the casing 1, opening outside this wall, via one or more orifices of various geometries, at an axial level different from that at which the other inlet 14.1, 14.2 opens into the chamber 11, also via one or more orifices of various geometries. In all cases, the inlet 14.1, which is located here lower than the inlet 14.2, constitutes a hot water inlet through which hot water enters the chamber 11 from outside the casing 1, while the inlet 14.2 constitutes a cold-water inlet through which cold water enters the chamber 11 from outside the casing 1.

In order to allow the mixed water contained in chamber 11 to leave the casing 1, the latter presents a mixed water outlet 16 which, in the example of the embodiment considered here, is centered on the X-X axis, and is delimited by the sleeve 13.

The cartridge 1 also includes a slide 20 mounted inside the chamber 11 in a manner movable along the X-X axis between two extreme positions, namely:
a lower extreme position, in which a seat 20.1 of the slide 20, which is located at a lower axial end of this slide and which runs all around the X-X axis, is in axial abutment against a seat 10.1 of the casing 10, which runs all around the X-X axis and which is located, along the X-X axis, substantially at the level of the outlet of the inlet 14.1 inside the chamber 11, and
an upper extreme position, in which a seat 20.2 of the slide 20, which is located at an upper axial end of the slide 20 and which runs all around the X-X axis, rests against a seat 10.2 of the casing 10, which runs all around the X-X axis and which is located, along the X-X axis, substantially at the level of the opening of the inlet 14.2 inside the chamber 11.

In the example of the embodiment considered here, and as clearly visible in FIG. 2, the seat 10.1 of the casing 10 is formed by an upper end edge of the sleeve 13, while the seat 10.2 of the casing is formed by an intermediate shoulder of the housing 12. As for the seats 20.1 and 20.2 of the slide 20, they are formed by end edges, respectively lower and upper, of an elastomeric layer 21 that coats an insert 22 of the slide 20. In practice, the insert 22 can be made of a metallic material or a plastic material, being over-molded by the elastomer to form the layer 21.

In all cases, the axial dimension of the slide 20, separating its opposite seats 20.1 and 20.2 from each other, is smaller than the axial distance separating the seats 10.1 and 10.2 of the casing 10 from each other. Thus, the seat 20.1 of the slide 20 and the seat 10.1 of the casing 10 delimit between them, along the X-X axis, a passage P1 which runs around the X-X axis and on which the inlet 14.1 opens into the chamber 11. Similarly, the seat 20.2 of the slide 20 and the seat 10.2 of the casing 10 delimit between them, along the X-X axis, a passage P2 which runs around the X-X axis and into which the inlet 14.2 opens into the chamber 11.

It is understood that, when the slide 20 is in its lower extreme position, the slide closes the passage P1 and thus completely closes, except for leaks, the hot water inlet inside the chamber 11, while opening to the maximum the cold-water inlet in this chamber via the open passage P2. Conversely, when the slide 20 is in its extreme upper position, the slide closes the passage P2 and thus completely closes, except for leaks, the cold-water inlet inside the chamber 11, while opening to the maximum the hot water inlet in this chamber via the passage P1. Of course, depending on the position of the slide 20 along the X-X axis between its extreme upper and lower positions, the respective closure of the passages P1 and P2 vary in an inverse manner, which amounts to saying that the quantities of hot and cold water admitted inside the chamber 11 are regulated, in respective proportions that are globally inverse, by the slide 20 according to its axial position.

In FIGS. 1 and 2, the slide 20 occupies an intermediate position between its extreme upper and lower positions. When the slide 20 is in this intermediate position, the passages P1 and P2 are open continuously all around the X-X axis. In other words, each of the passages P1 and P2 is open without any interruption along its periphery around the X-X axis, as clearly visible in FIG. 2. In practice, when the slide 20 is in the intermediate position, no contact is made between the seats 10.1 and 20.1 and, at the same time, no contact is made between the seats 10.2 and 20.2.

The slide 20 is mounted inside the chamber 11 by sealing the inlets 14.1 and 14.2 on the outside of the slide against each other. For this purpose, in the example of the embodiment considered here, the slide 20 presents an outer lip 23, which runs all around the outer side face of the slide and is pressed, radially to the axis, against the wall 15 of the chamber 11, so as to form a hot and cold-water seal between the inlets 14.1 and 14.2. This sealing lip 23 can advantageously be formed by the elastomer layer 21, by being integrated in one piece with this elastomer layer 21. Moreover, in order that the cold water admitted to the interior of the chamber 11 via the inlet 14.2 may join and mix with the hot water admitted to the chamber via the inlet 14.1, to form the mixed water flowing downstream of the slide 20 to the outlet 16, the slide 20 has one or more flow orifices 24 connecting the opposite axial faces of the slide to each other. This or these flow holes 24 can advantageously be delimited by the insert 22, in the form of several through holes, distributed around the X-X axis. It should be noted that the arrangements of the slide 20, such as the sealing lip 23, allowing the inlets 14.1 and 14.2 outside the casing to be sealed from each other, and the arrangements of the slide, such as the flow orifice(s) 24, allowing cold water to flow through the casing to join the hot water, are not limiting to the invention.

To drive the slide 20 in translation along the X-X axis, the cartridge 1 includes a thermostatic element 30 that includes a thermosensitive body 31 and a piston 32, which, in the assembled state of the cartridge components, are substantially centered on the X-X axis. The thermostatic element 30 is designed so that its thermosensitive body 31 and its piston 32 move relative to each other along the X-X axis, this relative movement being controlled by a temperature change applied to the thermosensitive body 31. For this purpose, the thermosensitive body 31 contains, for example, a thermally expandable material which, on expansion, causes the piston 32 to move relative to the thermosensitive body 31 and which, on contraction, allows the piston to retract relative to the thermosensitive body. Other forms of thermo-actuation are possible for the thermostatic element 30. In all cases, so that the relative axial displacement between the thermosensitive body 31 and the piston 32 is controlled by the temperature of the mixed water contained in the chamber 11, this thermosensitive body 31 is arranged to be in contact with the mixed water, being at least partially arranged in the chamber 11 and/or in the mixed water outlet 16.

The thermosensitive body 31 is rigidly connected to the slide 20, for example by screwing into the insert 22, it being emphasized that the form of this connection between the slide 20 and the thermosensitive body 31 is not limiting and, above all, that this connection extends as a kinematic connection from one to the other for the purpose of moving the slide to close off, in respective inverse proportions, the passages P1 and P2. The piston 32, in turn, is connected to the housing 10 by a mechanism, referenced 40 and detailed below.

Assuming that the mechanism 40 keeps the position of the piston 32 along the X-X axis fixed with respect to the casing 1, the temperature of the mixed water leaving the cartridge 1 is thermostatically regulated by the slide 20 and the thermostatic element 30. Indeed, in this hypothesis, the temperature of the mixed water is the direct result of the respective quantities of hot and cold water admitted into the chamber 11 via the passages P1 and P2, respectively, which are more or less closed off by the slide 20, as explained above. If the supply of hot and/or cold water to the cartridge is disturbed and, for example, the temperature of the mixed water increases, the piston 32 moves axially with respect to the thermosensitive body 31, which causes the thermosensitive body 31 and therefore the slide 20 to move downwards: the proportion of hot water flowing through the passage P1 decreases while, conversely, the proportion of cold water flowing through the passage P2 increases, which leads to a decrease in the temperature of the mixed water. An inverse reaction occurs when the temperature of the mixed water decreases, it being noted that a compression spring 33 is provided to return the thermostatic body 31 and the piston 32 towards each other when the latter retracts, for example upon contraction of the thermosensitive material contained in the thermosensitive body 31. In the example of the embodiment considered in the figures, this return spring 33 is interposed axially between the casing 1 and the slide 20. The correction of the mixed water temperature leads to a regulation balance for this mixed water temperature, and this at a thermostatically regulated temperature which depends on the position, imposed by the mechanism 40, of the piston 32 along the X-X axis.

The mechanism 40 allows adjusting the value of the thermostatically regulated temperature, by acting on the axial position of the piston 32. In the example considered here, this mechanism 40 comprises a stop 41, against which the upper end of the piston 32 is axially pressed and which is slidably mounted, along the X-X axis, inside a nut 42, with axial interposition between the stop 41 and the nut 42 of an overtravel spring 43. The axial position of the nut 42 inside the casing 10, and hence the height of the stop 41, can be modified by an adjusting screw 44, which is centered on the X-X axis and whose upper end is intended to be rotatably connected with an operating handle, not shown in the figures. At its lower end, the adjusting screw 44 is screwed into the nut 42, the latter being rotatably connected about the X-X axis to the casing 1, typically by splines. Thus, when the screw 44 is driven in rotation on itself about the X-X axis, the nut 42 translates along this axis, which causes the corresponding drive of the stop 41 through the intermediary of the overtravel spring 43, it being stressed that this overtravel spring 43 is substantially stiffer than the return spring 33.

The structure and operation of the adjustment mechanism 40 will not be further described here, it being understood that the reader may refer for this purpose to FR 2 869 087. It is recalled that the embodiment of this mechanism 40 is not limiting of the invention: other embodiments are known in the art, for example in FR 2 921 709, FR 2 774 740, and FR 2 870 611. Furthermore, as an alternative not shown, if the ability to adjust the value of the temperature at which the slide 20 regulates the mixing of hot and cold water is dispensed with, the mechanism 40 can be removed from the cartridge 1, the piston 32 then being fixedly connected to the casing 10.

We now return to a more detailed description of the slide 20, referring more specifically to FIGS. 2 and 3, FIG. 3 showing the slide 20 alone.

The slide 20 incorporates two reliefs, namely a lower relief 25.1, borne by the slide at its seat 20.1, and an upper relief 25.2, borne by the slide at its seat 20.2. Each of the reliefs 25.1 and 25.2 extends beyond the corresponding seat 20.1 and 20.2. Along the X-X axis, each relief 25.1, 25.2 thus extends across the fluid flow in the corresponding passage P1 and P2, as clearly visible in FIG. 2. Furthermore, each relief 25.1, 25.2 runs continuously all around the X-X axis, as clearly visible in FIG. 3.

The axial dimension of each relief 25.1, 25.2 is not constant around the X-X axis but, varies as the relief runs around the X-X axis, passing from a maximum value to a minimum value which may be zero. Thus, the lower end edge of the relief 25.1 is spaced axially from the seat 20.1 in a variable manner when this relief 25.1 runs about the X-X axis and the upper end edge of the relief 25.2 is spaced axially in a variable manner when this relief 25.2 runs about the X-X axis. In the example of the embodiment considered in FIGS. 2 and 3, these axial spacings vary continuously around the X-X axis, giving a wavy profile to the lower end edge of the relief 25.1 and to the upper end edge of the relief 25.2.

In all cases, the maximum axial dimension of each of the reliefs 25.1 and 25.2 is sufficiently small that neither of these reliefs 25.1 and 25.2 is in contact with the corresponding seats 10.1 and 10.2 of the casing 10 when the slide 20 is in the intermediate position of FIG. 2. Thus, when the slide 20 is in this intermediate position or is close to this intermediate position, the presence of the reliefs 25.1 and 25.2 leaves the passages P1 and P2 continuously open all around the X-X axis.

When the slide 20 is in its extreme lower position or close to this extreme lower position, the relief 25.1 interferes with the seat 10.1 of the casing 10: the relief 25.1 is then intended to be deformed by squeezing, the relief 25.1 being made of a suitable flexible material. Similarly, when the slide 20 is in its extreme upper position or close to this extreme upper position, the relief 25.2 interferes with the seat 10.2 of the casing 10: the relief 25.2 is then intended to be deformed by squeezing, this relief 25.2 being constituted of a suitable flexible material. In the embodiment considered in FIGS. 2 and 3, the reliefs 25.1 and 25.2 are, for this purpose, formed by the elastomer layer 21, being integrated into the latter in one piece. In all cases, when the slide 20 leaves its intermediate position and is moved to its lower extreme position, the relief 25.1 approaches axially the seat 10.1 of the casing 10, reducing at first progressively the free axial spacing which, as shown in FIG. 2, separates this relief 25.1 and this seat 10.1, until coming into contact with the relief 25.1, at the level of the portions of the latter where the relief has its greatest axial dimension: when the relief 25. 1 thus begins to interfere with the seat 10.1 of the casing 10, the passage P1 is no longer open in a continuous manner all around the X-X axis, which amounts to saying that the flow section of this passage is interrupted in several portions, which are distributed around the X-X axis and which correspond to the portions of the relief 25.1 having the maximum axial dimension of this relief. At the level of the portions of the passage P1, which are thus interrupted, the fluid flow is impossible, which amounts to saying that the speed of the fluid flow in these interrupted portions of the passage P1 is zero. In the other portions of the passage P1, the fluid flow is maintained. Of course, if the slide 20 is moved further towards the seat 10.1, if necessary to the lower position, the relief 25.1 is further pressed against the seat 10.1, by means of its flexible deformation, and the flow cross-section of the passage P1 is correspondingly reduced, but very rapidly, in the sense that the variation of the flow cross-section of the passage P1 is not linearly related to the axial travel of the slide 20, because the axial dimension of the relief 25.1 varies around the X-X axis. Thus, the relief 25.1 makes it possible, thanks to its shape, to slow down, in a non-uniform manner about the X-X axis, the flow of fluid in the passage P1 when the slide 20 is close to its extreme lower position, more generally when the slide 20 is axially between the intermediate position and this lower axial position. Of course, the squeezing of the relief 25.1 generates a resisting force with respect to the drive of the slide 20 controlled by the thermostatic element 30, but this resistance only comes into play when the slide 20 is close to the seat 10.1, which is equivalent to saying that the relief 25.1 does not induce any parasitic force against the displacement of the slide 20 as long as the slide 20 is in its intermediate position or close to this intermediate position. Moreover, when it is generated, the force induced by the squeezing of the relief 25.1 is very small given the small dimensions of this relief.

What has just been described for the passage P1 when the slide 20 leaves the intermediate position in the direction of the seat 10.1 is found in a corresponding manner for the passage P2 when the slide 20 leaves the intermediate position in the direction of the seat 10.2 of the casing 10.

It is understood that, since the fluid flow in the passages P1 and P2 is slowed down in a non-uniform manner around the X-X axis when the slide is close to these extreme upper and lower positions, the phenomenon of suction of the slide 20 against the seats 10.1 and 10.2, as described at the beginning of the present document, is prevented or, at least, limited in intensity since over a significant peripheral part of the passages P1 and P2, the fluid flow is prevented from reaching significant speeds.

FIGS. 4 to 10 respectively show casings 120, 220, 320, 420, 520, 620, 720, which are functionally similar to the slide 20 of FIGS. 2 and 3, but which differ from it in that the reliefs 25.1 and 25.2 of the slide 20 are respectively replaced by reliefs 125.1 and 125.2 for the slide 120, by reliefs 225.1 and 225.2 for the slide 220, by reliefs 325.1 and 325.2 for the slide 320, by reliefs 425.1 and 425.2 for the slide 420, by reliefs 525.1 and 525.2 for the slide 520, by reliefs 625.1 and 625.2 for the slide 620 and by reliefs 725.1 and 725.2 for the slide 720.

The reliefs 125.1, 125.2, 225.1, 225.2, 325.1, 325.2, 425.1, 425.2, 525.1, 525.2, 625.1, 625.2, 725.1 and 725.2 are, like the reliefs 25.1 and 25.2, borne by the corresponding slide 120, 220, 320, 420, 520, 620, 720 at the level of its seats 120.1 and 120.2, 220.1 and 220.2, 320.1 and 320.2, 420.1 and 420.2, 520.1 and 520.2, 620.1 and 620.2, 720.1 and 720.2: these reliefs protrude from these seats and are made of a flexible material adapted to be deformed by squeezing against the seat 10.1 of the casing 10 when the slide is in its lower extreme position and to be deformed by squeezing against the seat 10.2 of the casing 10 when the slide is in its upper extreme position. Advantageously, these reliefs are integrated into an elastomer layer similar to the elastomer layer 21 of the slide 20, produced in particular by overmolding.

Unlike the relief 25.1 provided as a single relief on the seat 20.1 of the slide 20, several reliefs 125.1, 225.1, 325.1, 425.1, 525.1, 625.1 and 725.1 are provided on the corresponding seat of the slide 120, 220, 320, 420, 520, 620, 720 and are distributed around the X-X axis, occupying, around this axis, respective portions which are distinct and separate. Likewise, unlike the relief 25.2 provided as a single relief on the seat 20.2 of the slide 20, a plurality of reliefs 125.2, 225.2, 325.2, 425.2, 525.2, 625.2, 725.2 are provided on the corresponding seat of the slide 120, 220, 320, 420, 520, 620, 720 and are distributed around the X-X axis, occupying, around this axis, respective portions which are distinct and separate. This being the case, the effect of reliefs 125.1, 125.2, 225.1, 225.2, 325.1, 325.2, 425.1, 425.2, 525.1, 525.2, 625.1, 625.2, 725.1 and 725.2 on the flow of fluid through the passages P1 and P2 is substantially identical to that of reliefs 25.1 and 25.2.

As shown in FIG. 4, each of the reliefs 125.1 and 125.2 presents an undulating profile.

As shown in FIG. 4, each of the reliefs 225.1 and 225.2 presents a pyramidal profile.

As shown in FIG. 6, each of the reliefs 325.1 and 325.2 presents a pyramidal profile, different from that of the reliefs 225.1 and 225.2.

As shown in FIG. 7, each of the reliefs 425.1 and 425.2 presents an undulating profile, different from that of reliefs 125.1 and 125.2.

As shown in FIG. 8, reliefs 525.1 and 525.2 present a crenellated profile.

As shown in FIG. 9, the reliefs 625.1 and 625.2 present a spiked profile.

As shown in FIG. 10, each of the reliefs 725.1 and 725.2 presents a pyramidal profile, different from that of the reliefs 225.1 and 225.2 and from that of the reliefs 325.1 and 325.2.

FIG. 11 shows a casing 810 and a slide 820, which are functionally similar to the casing 10 and the slide 20 of FIGS. 1 and 2, but which differ from them, among other things, by the fact that the seats 820.1 and 820.2 of the slide 820 are devoid of reliefs in favor of the seats 810.1 and 810.2 of the casing 810. Thus, the casing 810 carries reliefs 817.1 which are functionally similar to the relief 25.1 and its variants of FIGS. 4 to 10: the reliefs 817.1 protruding from the seat 810.1, are distributed around the X-X axis, occupying around this axis distinct and separate respective portions, and are made of a flexible material adapted to be deformed by squeezing by the seat 820.1 of the slide 820 when the slide is in its extreme lower position. In the example of the embodiment considered here, the reliefs 817.1 are formed by a gasket, in particular of elastomer, which is integrated into the casing 810, for example by overmolding. Similarly, the casing 810 carries reliefs 817.2 which are functionally similar to the relief 25.2 and its variants of FIGS. 4 to 10: the reliefs 817.2 protruding from the seat 810.2, are distributed around the X-X axis, occupying around this axis respective distinct and separate portions, and are made of a flexible material adapted to be deformed by squeezing by the seat 820.2 of the slide 820 when the slide is in the extreme upper position. In the example of the embodiment considered here, these reliefs 817.2 are formed by a gasket, in particular of elastomer, which is integrated into the casing 810, for example by overmolding.

The slide 820 can, as in the example of the embodiment considered here, be structurally distinguished from the slide 20, by including a main body 826 designed to ensure, at the same time, the connection of the slide 820 to the thermosensitive body 31 of the thermostatic element 30 and the formation of the seats 820.1 and 820.2, this main body 826 being equipped, on its outer lateral face, with an O-ring 827 ensuring the sealing between the passages P1 and P2 on the outside of the slide 820.

FIGS. 12 and 13 show a casing 910 and a slide 920, which are functionally similar to the casing 10 and the slide 20, but which differ from them, among other things, by the fact that, instead of incorporating deformable reliefs such as reliefs 25.1 and 25.2 and their variants of FIGS. 4 to 11, the slide 920 incorporates rigid reliefs 925.1 and 925.2, more precisely reliefs 925.1 that are rigidly connected to the seat 920.1 of the slide 20 and reliefs 925.2 that are rigidly connected to the seat 920.2 of the slide 920. More specifically, the reliefs 925.1 and 925.2 rigidly protrude from the seats 920.1 and 920.2 axially across the fluid flow in the passages P1 and P2 respectively delimited between the seat 920.1 and the corresponding seat of the casing 910 and delimited between the seat 920.2 and the corresponding seat of the casing 910. The seats of the casing 910, against which the seats 920.1 and 920.2 of the slide 920 are in contact when the slide is in the upper and lower end positions, are provided with one or more recessed housings, which are complementary to the reliefs 925.1 and 925.2 and in which these reliefs are received when the slide is in the upper and lower end positions: such a housing, referenced 918.1, is visible in FIG. 13 for the seat 910.1 of the casing 910.

In the example of the embodiment considered in FIGS. 12 and 13, the slide 920 is, apart from these reliefs 925.1 and 925.2, structurally similar to the slide 820.

Functionally, the reliefs 925.1 and 925.2 are similar to the reliefs 25.1 and 25.2 and their variants of FIGS. 4 to 11, in the sense that they make it possible to avoid or limit the appearance of the phenomenon of suction of the slide 920 when this slide is close to its extreme upper and low positions. However, unlike the deformable reliefs such as reliefs 25.1, 25.2 and their variants of FIGS. 4 to 11, which act on the fluid flow in the passages P1 and P2 by playing on the non-linearity of the variation of the flow section of these passages as a function of the stroke of the slide, the reliefs 925.1 and 925.2 act on the fluid flow in the passages P1 and P2 by creating pressure drops which are irregular around the X-X axis. Thus, in the example of the embodiment considered here, the reliefs 925.1 are distributed around the X-X axis, occupying, around this axis, respective portions that are distinct and separate. Similarly, the reliefs 925.2 are distributed around the X-X axis, occupying, around this axis, respective distinct and separate portions. The result is that, when the slide 920 is axially between the intermediate position of FIG. 2 and one or other of its upper and lower extreme positions, in particular when the slide is close to one or other of its upper and lower extreme positions, the reliefs 925.1 or 925.2 induce, in the portions of the passage P1 or P2 at the level of which these reliefs are located, local losses of pressure which thus slow down the flow of fluid non-uniformly about the X-X axis.

Of course, the precise shape of the rigid reliefs 925.1 and 925.2 is not limited to that of FIGS. 12 and 13.

FIGS. 14 and 15 show a casing 1010 and a slide 1020, which are similar to the casing 910 and the slide 920 except that the arrangement of the rigid reliefs and the housings intended to receive them are inversed between the casing and the slide, in the sense that the rigid reliefs 925.1 and 925.2 of the slide 920 are replaced by rigid reliefs borne by the seats of the casing 1020. Thus, in the embodiment shown in FIGS. 14 and 15, the casing 1010 incorporates reliefs 1017.1, which rigidly protrudes from the seat 1010.1 and which are received in one or more complementary recesses 1028.1 hollowed out in the seat 1020.1 of the slide 1020 when the latter is in its extreme lower position.

FIGS. 16 and 17 show a casing 1110 and a slide 1120, which are similar to the casing 910 and the slide 920 of FIGS. 12 and 13, with the main difference being that the rigid reliefs, referenced 1125.1 and 1125.2, carried by the slide 1120 do not extend axially across the passages P1 and P2 as do the reliefs 925.1 and 925.2, but extend axially across the inlet of these passages P1 and P2. More precisely, as is clearly visible in FIGS. 16 and 17, the reliefs 1125.1, which are distributed around the X-X axis by occupying, around this axis, respective distinct and separate portions, protruding from a surface 1129.1 of the slide 1120, which is located at the inlet of the passage P1 and which extends the seat 1120. 1 of the slide in the direction opposite to the X-X axis, without being brought into contact with the seat 1110.1 whatever the axial position of the slide 1120. Similarly, the reliefs 1125.2, which are distributed around the X-X axis, occupying, around this axis, respective distinct and separate portions, protrude from a surface 1129.2 of the slide 1120, which is situated at the entrance of the inlet P1 and which extends the seat 1120.2 of the slide 1120 in the opposite direction to the X-X axis without being brought into contact with the seat 1110.2 of the casing 1110 whatever the axial position of the slide 1120. The effect that the reliefs 1125.1 and 1125.2 produce on the flow of fluid in the passages P1 and P2 when the slide is close to either of its extreme upper and lower positions is the same as for the reliefs 925. 1 and 925.2, in the sense that the reliefs 1125.1 and 1125.2 slow down the fluid flow in the passages P1 and P2 in a non-uniform manner about the X-X axis, but this effect of slowing down results from the pressure losses and disturbances that these reliefs 1125.1 and 1125.2 produce on the fluid flow at the inlet of the passages P1 and P2, just upstream of these passages P1 and P2.

The arrangement of the reliefs 1125.1 and 1125.2 at the inlet of the passages P1 and P2 makes it possible to avoid providing recessed housings in the seat on which the seat bearing the rigid reliefs rests when the slide closes the corresponding passage.

Of course, the precise shape of the reliefs 1125.1 and 1125.2 is not limited to that of FIGS. 16 and 17, in which these reliefs have a crenellated profile. Thus, FIGS. 18 and 19 illustrate an alternative geometry of similar reliefs, which are referenced 1225.1 and 1225.2 and which have an undulating profile.

Furthermore, following considerations similar to those on which the distinction between the embodiment of FIGS. 12 and 13 and the embodiment of FIGS. 14 and 15 is based, the arrangement of reliefs 1125.1 and 1125.2 and reliefs 1225.1 and 1225.2 can be inversed between the slide and the casing. Thus, in FIGS. 20 and 21, which represent a casing 1310 and a slide 1320 functionally similar to the casing 1110 and the slide 1120, reliefs 1317.1 are provided in protrusion from a surface 1319.1 of the casing 1310, which is located at the inlet to the passage P1 and which extends the seat 1310.1 of the casing 1310 in the direction opposite to the X-X axis without being brought into contact with the seat 1320.1 of the slide 1320 whatever the axial position of the slide 1320.

FIGS. 22 and 23 show a casing 1410 and a slide 1420, which are similar to the casing 1110 and the slide 1120 of FIGS. 16 and 17, with the main difference that the rigid reliefs, referenced 1425.1 and 1425.2, carried by the slide 1420 do not extend across the entrance of the passages P1 and P2 like the reliefs 1125.1 and 1125.2, but extend axially across the outlet of these passages P1 and P2. More precisely, as is clearly visible in FIGS. 22 and 23, the reliefs 1425.1 protrude from a surface 1429.1 of the slide 1420, which is located at the outlet of the passage P1 and which extends the seat 1420.1 of the casing in the direction of the X-X axis without being brought into contact with the seat 1410.1 of the casing 1410 whatever the axial position of the casing. Similarly, the reliefs 1425.2 protrude from a surface 1429.2 of the slide 1420, which is located at the outlet of the passage P2 and which extends the seat 1420.2 of the slide in the direction of the X-X axis without being brought into contact with the seat 1410.2 of the casing 1410 whatever the axial position of the slide 1420. Following considerations similar to those given above in connection with the reliefs 1125.1 and 1125.2, the reliefs 1425.1 and 1425.2 produce pressure losses and disturbances on the fluid flow at the outlet of the passages P1 and P2, just downstream of these passages P1 and P2: these pressure losses and these downstream disturbances induce, on the fluid flow in the passages P1 and P2, a slowing down that is non-uniform about the X-X axis.

Of course, the precise shape of the reliefs 1425.1 and 1425.2 is not limited to that of FIGS. 22 and 23, in which these reliefs have a crenellated profile. Thus, FIGS. 24 and 25 illustrate an alternative geometry of similar reliefs, which are referenced 1525.1 and 1525.2 and which present an individual pyramidal profile.

Also, as previously related to FIGS. 20 and 21, the arrangement of reliefs 1425.1 and 1425.2 and reliefs 1525.1 and 1525.2 can be inversed between the slide and the casing. Thus, in FIGS. 26 and 27, which represent a casing 1610 and a slide 1620 that are functionally similar to the casing 1410 and the slide 1420, reliefs 1617.1 are provided in protrusion from a surface 1619.1 of the casing 1610, which is located at the outlet of the passage P1 and which extends the seat 1610.1 of the casing in the direction of the X-X axis without being brought into contact with the seat 1620.1 of the slide 1620 whatever the axial position of the slide.

FIGS. 28 to 30 show a casing 1710 and a slide 1720, which are functionally similar to the casing 1610 and the slide 1620, with the main difference that the rigid reliefs, which are referenced 1717.1 and 1717. 2, which the casing 1710 carries across the fluid flow at the inlet of the passages P1 and P2, do not protrude from a surface prolonging the seats of the casing as for the reliefs 1617.1, but extend across inlets 1714.1 and 1714.2 of the casing 1710, which are respectively similar to inlets 14.1 and 14.2 of the casing 10. More specifically, as clearly visible in FIG. 30, the reliefs 1717.1 protrude from a surface 1719.1 of the casing 1710, which delimits the inlet 1714.1. Similarly, as clearly visible in FIG. 29, the reliefs 1717.2 protrude from a surface 1719.2 of the casing 1710, which delimits the inlet 1714.2.

The pressure drops and disturbances that reliefs 1717.1 and 1717.2 produce on the fluid flow at the inlet of passages P1 and P2 are similar to those produced by reliefs 1425.1, 1425.2, 1525.1, 1525.2 and 1617.1.

Finally, various arrangements and variants of the thermostatic assemblies described so far are also conceivable. By way of example:
rather than the relief(s) associated with the passage P1 being identical to the relief(s) associated with the passage P2, as envisaged in the various embodiments illustrated in the figures, the relief(s) associated with the passage P1 may be different from the relief(s) associated with the passage P2; thus, within the same thermostatic assembly, any one of the embodiments of the reliefs contemplated in the figures may be used for one of the passages P1 and P2 and any other of the embodiments of the reliefs contemplated in the figures may be used for the other of the passages P1 and P2; and/or
rather than the casing, the slide, and the thermostatic element, and optionally the mechanism 40, being assembled together as a cartridge capable of being integrally fitted into a faucet body, such that the cartridge 1 contemplated above, the slide and the thermostatic element, and optionally the mechanism 40, may be installed directly into a faucet body, the latter then forming a casing functionally similar to the casing of the cartridge.

1. A thermostatic assembly, including:
a casing in which are defined:
a chamber which defines an axis and in which a hot fluid and a cold fluid mix to form a mixed fluid,
a hot fluid inlet through which the hot fluid enters the chamber from outside the casing,
a cold fluid inlet through which the cold fluid enters the chamber from outside the casing, and
a mixed fluid outlet through which the mixed fluid contained in the chamber leaves the casing,
a thermostatic element which includes a thermosensitive body, arranged to be in contact with the mixed fluid, and a piston, connected to the casing, the thermosensitive body and the piston moving relative to each other along the axis according to the temperature of the mixed fluid, and
a slide for regulating the temperature of the mixed fluid, this slide being arranged in the chamber so as to be movable along the axis in such a way that:
a first seat of the slide and a first seat of the casing delimit between them, along the axis, a first passage which runs around the axis and into which the hot fluid inlet opens in the chamber, this first passage being closed when the slide occupies a first axial position in which the first seat of the slide is in axial contact against the first seat of the casing,
a second seat of the slide and a second seat of the casing delimit between them, along the axis, a second passage which runs around the axis and on which the cold fluid inlet opens in the chamber, this second passage being closed when the slide occupies a second axial position in which the second seat of the slide is in axial contact against the second seat of the casing, and
the first and second passages are open continuously all around the axis when the slide occupies an intermediate axial position between the first and second positions,
wherein the slide is connected to the thermosensitive body of the thermostatic element to be displaced along the axis so as to close the first and second passages in respective inverse proportions,
and wherein the thermostatic assembly incorporates:
one or more first reliefs, which are arranged in or at inlet or at outlet of the first passage and which are shaped to slow down, non-uniformly around the axis, a first fluid flow in the first passage when the slide is axially between the intermediate position and the first axial position, and
one or more second reliefs, which are arranged in or at inlet or at outlet of the second passage and which are shaped to slow down, non-uniformly around the axis, a second fluid flow in the second passage when the slide is axially between the intermediate position and the second axial position.

2. The thermostatic assembly according to claim 1, wherein each of the first and second reliefs is borne by the slide or by the casing.

3. The thermostatic assembly according to claim 1, wherein the or each first relief extends axially across the first fluid flow in or at inlet or at outlet of the first passage, and wherein the or each second relief extends axially across the second fluid flow in or at inlet or at outlet of the second passage.

4. The thermostatic assembly according to claim 1, wherein:
a single first relief, which runs continuously all around the axis and whose axial dimension varies as this first relief is followed around the axis, or
a single second relief, which runs continuously around the axis and whose axial dimension varies as this second relief is followed around the axis.

5. The thermostatic assembly according to claim 1, wherein:
a plurality of first reliefs which are distributed about the axis and which occupy, about the axis, respective portions which are distinct and separate, or
a plurality of second reliefs which are distributed around the axis and which occupy respective portions which are distinct and separate around the axis.

6. The thermostatic assembly according to claim 1, wherein:
the first relief or reliefs protrude from the first seat of the slide or of the first seat of the casing, being made of a flexible material adapted to be deformed by squeezing when the slide is in the first axial position, or
the second relief or reliefs protrude from the second seat of the slide or of the second seat of the casing, being made of a flexible material adapted to deform by squeezing when the slide is in the second axial position.

7. The thermostatic assembly according to claim 1, wherein:
the first relief or reliefs rigidly protrude from the first seat of the slide or from the first seat of the casing, being received in a complementary recess hollowed out in, respectively, the first seat of the casing or the first seat of the slide when the slide is in the first axial position, or
the second relief or reliefs rigidly protrude from the second seat of the slide or from the second seat of the casing, being received in a complementary recess hollowed out in, respectively, the second seat of the casing or the second seat of the slide when the slide is in the second axial position.

8. The thermostatic assembly according to claim 1, wherein:
the first relief or reliefs protrude from a dedicated surface of the slide or of the casing, which is located at inlet of the first passage and which extends the first seat of the slide or the first seat of the casing opposite to the axis without being brought into contact with, respectively, the first seat of the casing or the first seat of the slide whatever the axial position of the slide in the chamber, or
the second relief or reliefs protrude from a dedicated surface of the slide or casing, which is located at inlet of the second passage and which extends the second seat of the slide or the second seat of the casing opposite to the axis without being brought into contact with, respectively, the second seat of the casing or the second seat of the slide regardless of the axial position of the slide in the chamber.

9. The thermostatic assembly according to claim 1, wherein:
the first relief or reliefs protrude from a dedicated surface of the slide or of the casing, which is located at outlet of the first passage and which extends the first seat of the slide or the first seat of the casing toward the axis without being brought into contact with, respectively, the first seat of the casing or the first seat of the slide whatever the axial position of the slide in the chamber, or
the second relief or reliefs protrude from a dedicated surface of the slide or of the casing, which is located at outlet of the second passage and which extends the second seat of the slide or the second seat of the casing toward the axis without being brought into contact with, respectively, the second seat of the casing or the second seat of the slide whatever the axial position of the slide in the chamber.

10. The thermostatic assembly according to claim 1, wherein:
the first relief or reliefs protrude from a surface of the casing, which delimits the hot fluid inlet, or
the second relief or reliefs protrude from a surface of the casing, which delimits the cold fluid inlet.

11. The thermostatic assembly according to claim 1, wherein the thermostatic assembly forms a thermostatic cartridge adapted to be integrally fitted into a faucet body.
